(19) United States
(12) Patent Application Publication
(10) Pub. No.: US 2014/0085882 A1
(43) Pub. Date: Mar. 27, 2014

(54) LED WORK LIGHT

(71) Applicant: CHECKERS INDUSTRIAL PRODUCTS, LLC, Broomfield, CO (US)

(72) Inventor: Scott Clifford, Mesa, AZ (US)

(73) Assignee: Checkers Industrial Products, LLC, Broomfield, CO (US)

(21) Appl. No.: 13/797,488

(22) Filed: Mar. 12, 2013

Related U.S. Application Data
(60) Provisional application No. 61/704,309, filed on Sep. 21, 2012.

(51) Int. Cl. F21V 5/04

(52) U.S. Cl. CPC F21V 5/04
USPC 362/235

(57) ABSTRACT

An LED work light assembly includes a housing defining light chamber, a plurality of LED lights positioned in the light chamber, and a lens assembly secured to the housing with a liquid-tight connection to create a waterproof environment in the light chamber. The LED work light assembly also includes a mounting arrangement carried by the housing and comprising a pivot mount that includes a spherical socket and a bolt having a spherical ball positioned at one end and a threaded shaft at an opposite end. The ball is positioned in the socket to provide a ball-and-socket interface, and the housing is pivotal about the ball-and-socket interface to adjust a position of the housing relative to the bolt.

### RELATED APPLICATION

This claims the benefit of U.S. Provisional Application No. 61/704,309, filed 21 Sep. 2012, which is hereby incorporated by reference herein in its entirety.

### BACKGROUND

Many types of work lights are available. Work lights range in size from large flood lights mounted to a portable cart, to handheld work lights that can be mounted to a work bench or positioned within a confined workspace. The use of LEDs in work lights provides a number of advantages over some types of work lights that include incandescent, halogen or fluorescent bulbs. For example, LED lights may provide improved luminescence for the amount of power used. Further, LED lights may have a smaller size, thus resulting in a smaller work light package.

Opportunities exist for improving mounting structures for work lights and light output from work lights that use LEDs.

### SUMMARY

As will be described in greater detail below, one aspect of the present disclosure relates to an LED work light assembly. The LED work light assembly includes a housing defining a light chamber, a plurality of LED lights positioned in the light chamber, and a lens assembly secured to the housing with a liquid-tight connection to create a waterproof environment in the light chamber. The LED work light assembly also includes a mounting arrangement carried by the housing and comprising a pivot mount that includes a spherical socket and a bolt having a spherical ball positioned at one end and a threaded shaft at an opposite end. The ball is positioned in the socket to provide a ball-and-socket interface, and the housing is pivotal about the ball-and-socket interface to adjust a position of the housing relative to the bolt.

The pivot mount may further include a locking screw operable to apply a compression force on the ball-and-socket interface to lock a position of the housing relative to the bolt. The mounting arrangement may further include at least first and second panel mount members extending from a rear surface of the housing and configured to secure the LED work light assembly to a mounting structure. The lens assembly may include a separate optic for each LED light. The LED lights may generate a total of at least 2,000 lumens of light for the LED work light assembly. The light chamber may be open along a front surface of the housing. The LED lights may operate in the range of about 30 Watts. The optics may be configured to control a direction of light emitted from the LED lights. The direction of light may be one of a less than 10° tight pattern and a 15°×27° wide pattern. The LED work light assembly may include an actuator accessible on an exterior of the housing and operable to change a setting of at least one of the LED lights.

Another aspect of the present disclosure relates to an LED work light assembly that includes a housing, a plurality of LED lights, a lens, and a ball-and-socket mount. The housing includes a light chamber accessible along a front surface of the housing. The plurality LED lights are independently controllable and positioned in the light chamber. The lens assembly is mounted to the front surface of the housing and having a fluid-tight interface with the housing. The lens assembly includes a separate optic associated with each of the plurality of LED lights, and the optics restrict a direction of light output from the plurality of LED lights. The ball-and-socket mount is connected to the housing and provides unrestricted pivotal movement of the housing about multiple axis of rotation.

The ball-and-socket mount may include a spherical socket formed in the housing, and a mounting bolt having a spherical shaped ball at one end thereof that is positioned in the spherical socket. The LED work light assembly may include a locking member operable to fix a rotated position of the ball relative to the socket.

The mounting bolt may extend vertically downward from a bottom surface of the housing. The locking member may include a threaded shaft having a distal end that contacts the ball to apply a compression force on the ball. The housing may include a plurality of fins along an exterior surface thereof, the plurality of fins providing heat dissipation from the LED work light. At least some of the plurality of fins may be positioned along a rear surface of the housing and extend away from the lens assembly.

A further aspect of the present disclosure relates to a method of operating an LED work light assembly. The method includes providing a housing, at least one LED light positioned in the housing, a lens assembly mounted to the housing with a fluid-tight connection, a spherical socket formed in the housing, a mounting member having a ball with a spherical portion, and a locking member. The method further includes positioning the ball in the socket, pivoting the housing relative to the mounting member about any one of a plurality of axis of rotation, and moving the locking member into contact with the ball to lock a position of the housing relative to the mounting member.

Positioning the ball in the socket may include inserting the ball through a threaded bore, wherein the locking member threadably engages the threaded bore after inserting the ball. The locking member may include a concave portion that contacts the ball to provide a surface contact. Moving the locking member may include rotating the locking member relative to the housing. The mounting member may include a threaded shaft, and the method further includes arranging the threaded shaft extending from a bottom surface of the housing. The housing may include a heat dissipation structure along an exterior surface thereof, and the method further includes dissipating heat from the plurality of LED lights through the heat dissipation structure.

Features from any of the above-mentioned embodiments may be used in combination with one another in accordance with the general principles described herein. These and other embodiments, features and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a perspective view of an example LED work light assembly in accordance with the present disclosure.

FIG. 2 is another perspective view of the LED work light assembly of FIG. 1.

FIG. 3 is a front view of the LED work light assembly of FIG. 1.

FIG. 4 is a right side view of the LED work light assembly of FIG. 1.

FIG. 5 is a rear view of the LED work light assembly of FIG. 1.

FIG. 6 is a top view of the LED work light assembly of FIG. 1.

FIG. 7 is a left side view of the LED work light assembly of FIG. 1.

FIG. 8 is a bottom view of the LED work light assembly of FIG. 1.

FIG. 9 is an exploded perspective view of the LED work light assembly of FIG. 1.

FIG. 10 is a cross-sectional view of the LED work light assembly of FIG. 6 taken along cross-section indicators 10-10.

FIG. 11 is a perspective view of the cross-section shown in FIG. 10.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, one of skill in the art will understand that the exemplary embodiments described herein are not intended to be limited to the particular forms disclosed. Rather, the instant disclosure covers all modifications, equivalents, and alternatives falling within the scope defined by the appended claims.

### DETAILED DESCRIPTION OF EXEMPLARY EMBODIMENTS

As will be described in greater detail below, the present disclosure relates generally to work lights, and more specifically relates to LED work lights. The present disclosure particularly relates to mounting systems and light control features for LED work lights.

One aspect of the present disclosure relates to an LED work light assembly having a mounting arrangement that provides pivoting of the LED work light assembly about multiple axis of rotation. The mounting arrangement may include, for example, a ball-and-socket mounting.

Another aspect of the present disclosure relates to controlling a light output from the LED lights, such as an output angle for the LED lights. The light output may be controlled using an optic. The optic may include a separate optic portion for each LED. The optic may direct the light in a tight beam angle (e.g., less than 15°), a wide angle (e.g., height in the range of about 5° to 15° and a width in the range of about 20° to 45°), a spread pattern in the range of about 20° to 45°, a diffuse pattern with an angle greater than 45°, or a combination of the above options using separate LEDs of the LED work light assembly. For example, the LED work light assembly may include at least two LEDs and each LED has a separate optic, and the optics for at least two of the LEDs are different to provide the desired combination pattern.

The LED work light assembly may include a control member that independently controls at least some of the LEDs. The controller may operate to turn on and off certain of the LEDs to provide a desired light pattern associated with a given LED (e.g. a wide, tight, spread, or diffuse light pattern), or a combination thereof.

The mounting arrangement of the LED work light assembly may include multiple mounting features. For example, the mounting arrangement may include a ball-and-socket connector to provide pivot capability about a plurality of axis of rotation. The mounting arrangement may also include an optional panel mount arrangement that holds the LED work light assembly in a fixed mounted position.

The ball-and-socket mounting features may include a socket formed in a housing of the LED work light assembly, wherein the socket has a spherical shaped portion. The ball-and-socket arrangement may also include a bolt having a threaded shank at one end and a ball feature at an opposite end. The ball feature may include a spherical shaped portion that interfaces with the spherical portion of the socket to provide pivoting of the housing about multiple axes of rotation. The ball-and-socket mounting arrangement may include a set screw that is adjustable to vary a compression force applied to the ball in the socket. The set screw may assist in locking or holding the housing in a given rotated position.

In at least one example, the bolt of the ball-and-socket arrangement extends vertically downward from the housing. Other arrangements are possible in which the bolt extends from a rear surface, a top surface, or one of the side surfaces of the housing.

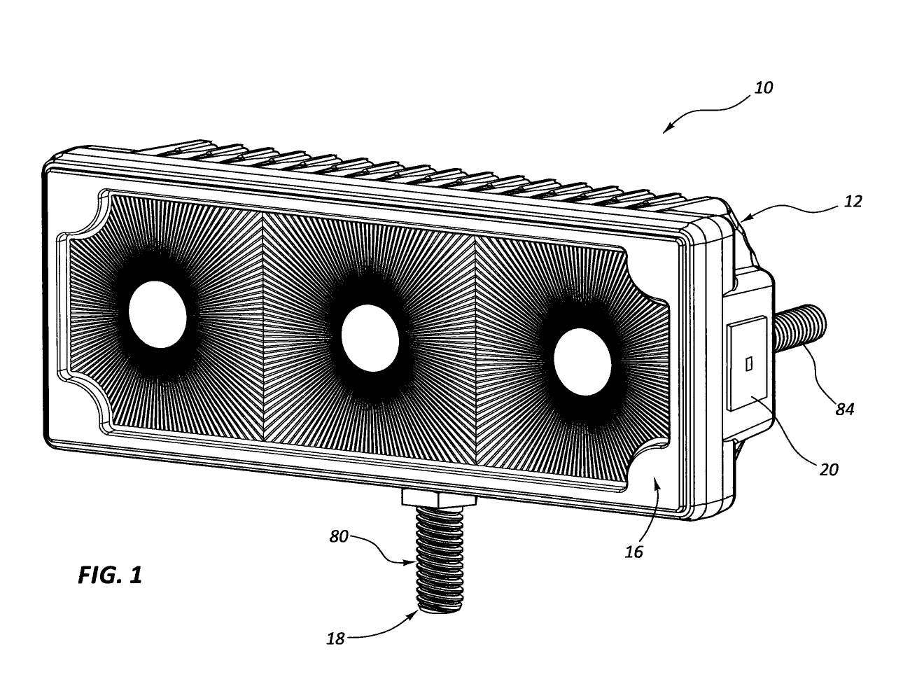

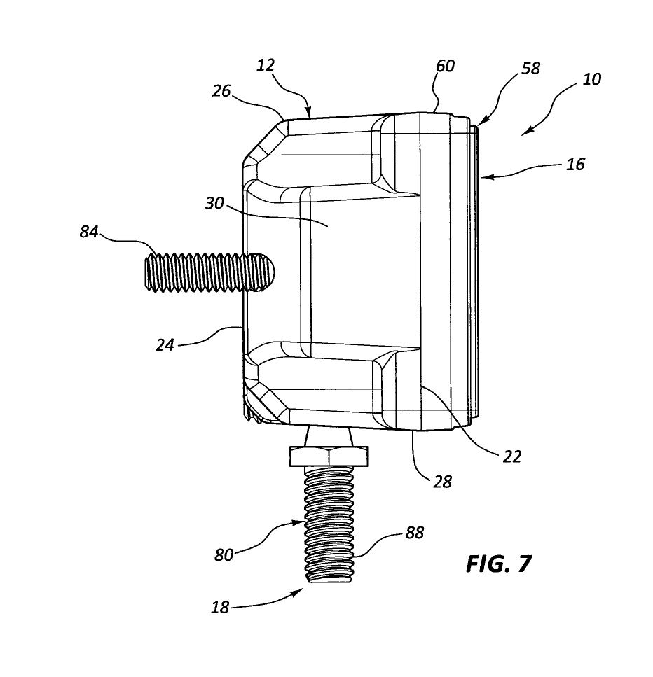

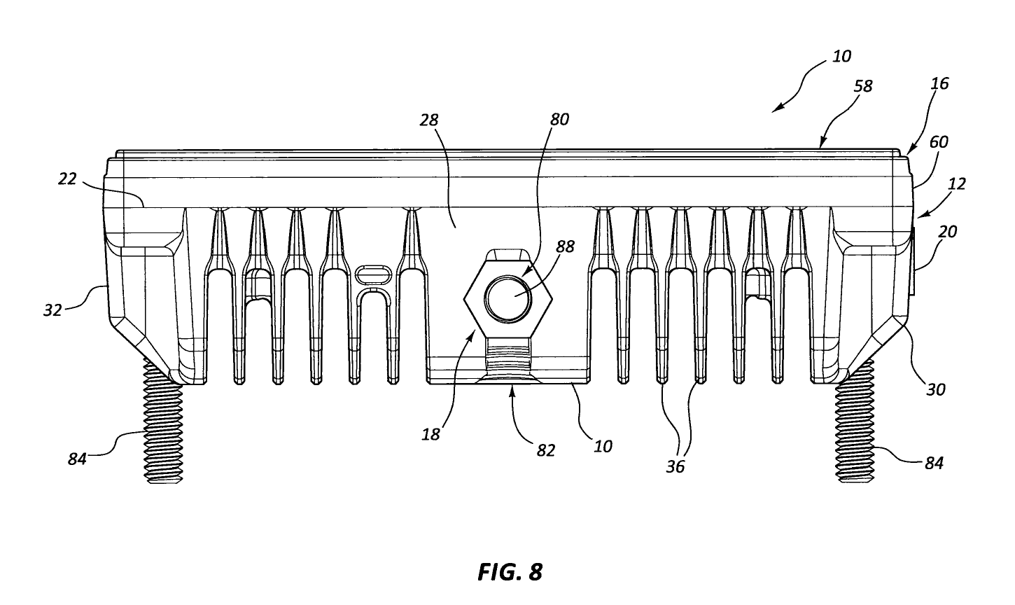

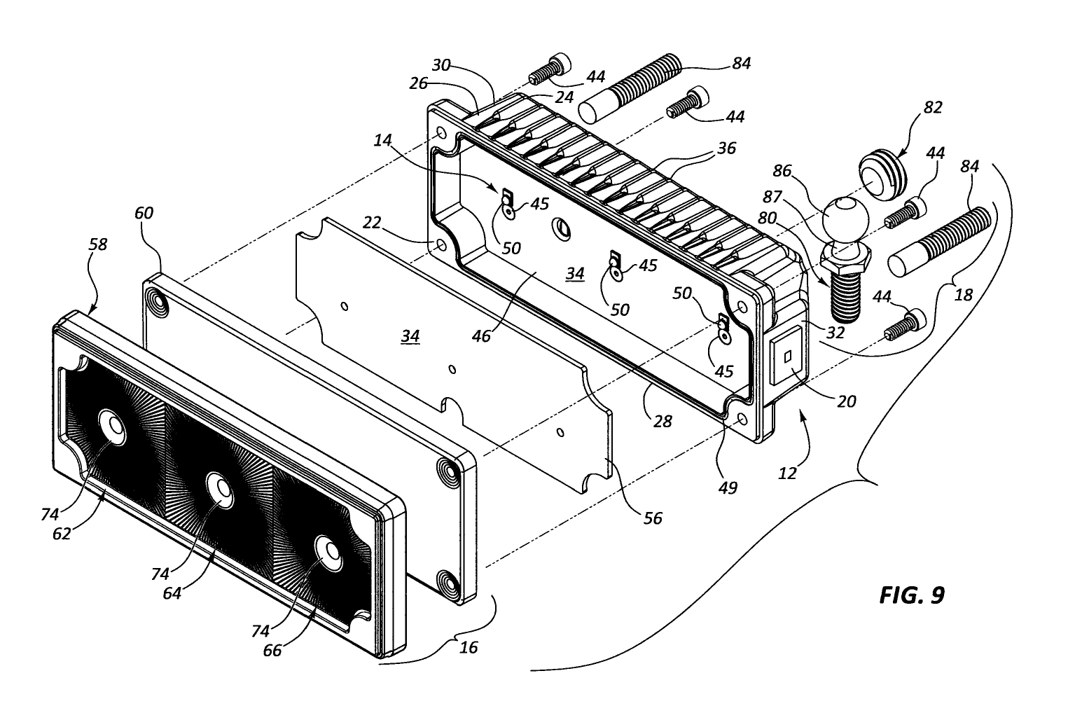

Referring now to FIGS. 1-11, an example LED work light assembly 10 is shown including a housing 12, an LED light assembly 14, a lens assembly 16, a mounting arrangement 18, and a controller 20. The LED light assembly 14 is positioned within an interior of the housing 12 as shown in FIGS. 9-11. The lens assembly 16 is mounted to a front surface of the housing 12. The mounting arrangement 18 is positioned along a rear and bottom surface of the housing 12. The controller 20 may be positioned at any location along an exterior of the housing 12 so as to be accessible by an operator. The controller 20 is shown positioned along a side surface of the housing.

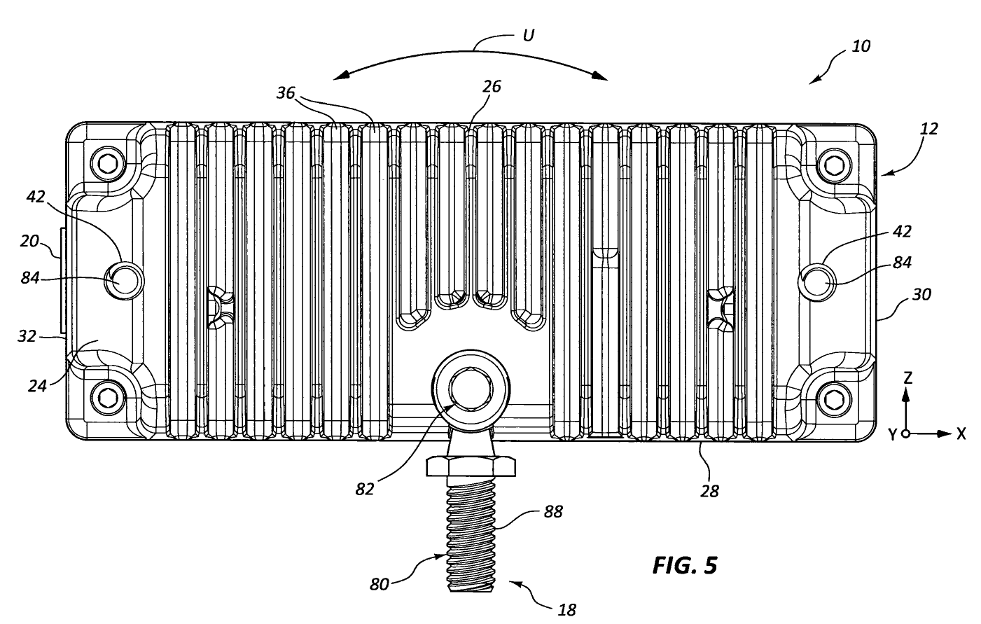

Referring to FIGS. 5 and 9, the housing 12 includes front and rear surfaces 22, 24, top and bottom surfaces 26, 28, first and second side surfaces 30, 34, and a cavity 34. The housing 12 also includes a plurality of heat dissipation fins 36, a socket 38, a socket bore 40, mounting bores 42, a plurality of lens attachment bolts 44, and a sealing member 49. The housing 12 may comprise a material having a high heat conduction property. In one example, the housing 12 comprise a metal material such as copper or aluminum. The materials of the housing 12 may assist in drawing heat away from the LED light assembly 14, and then dissipate the conducted heat via the heat dissipation fins 36.

A cavity 34 is sized to house the LED light assembly 14 and at least a portion of the lens assembly 16. The cavity 34 includes a rear wall 46. The LED light assembly 14 includes first, second and third lights 50, 52, 54 mounted to a printed circuit board (PCB) 56 (see FIGS. 9-11). The LED work light assembly 10 is secured to the rear wall 46 using a plurality of fasteners 45 (e.g., screws).

The fasteners 45 may provide not only the function of mounting the PCB 56 and LED light assembly 14 to the housing, but more importantly provide direct pressure very close to the LED to draw heat from the LED to the housing 12 and specifically the heat dissipation fins 36. At least some arrangements of the LED light assembly 14 includes high power LED's that operate at high temperatures and generate large amounts of heat. It may be important to move this heat away from the LEDs in order to avoid possible degradation of the LED brightness and/or a reduction in operational life time of the LEDs.

The PCB 56 may comprise a thin (e.g., in the range of about 0.010 inch to about 0.05 inch) double sided FR4 2 oz. copper material. The PCB 56 may also include copper vias that assist in moving the heat from the LEDs to the housing 12. The relatively thin construction and associated smaller thermal path of the PCB 56, along with the use of copper vias (e.g., small copper plated through-holes) and the pressure of the fasteners 45 positioned adjacent to the LEDs, an improved thermal interface is provided that provides increase heat conduction away from the LEDs into the housing 12. Copper may provide improved heat conduction as compared to other materials. For example, copper may be rated as being two times better at moving heat than aluminum. The fasteners may apply pressure to the interface between the copper PCB 56 and the aluminum housing 12. The improved heat transfer possible by this combination of materials and structure used in the LED work light assembly 10 may permit driving additional current to the LED to produce more light under all conditions while maintaining the LEDs at a temperature below critical level that may otherwise create damage to the LEDs.

The fasteners 45 may be positioned at any location on the PCB 56 relative to the LEDs 50, 52, 54. In at least some arrangements, a plurality of fasteners 45 may be positioned in close proximity to each of the LEDs 50, 52, 54.

The heat dissipation fins 36 may act as a heat sink for the LED work light assembly 10. The heat dissipation fins 36 may extend from the rear surface 24 and may define at least in part the rear surface 24 of housing 12. The heat dissipation fins 36 may be arranged vertically as shown in the figures. Other arrangements are possible in which the heat dissipation fins extend in a horizontal direction or extend from top, bottom, or side surfaces of the housing 12. The heat dissipation fins 36 may be formed integrally with other portions of housing 12. The heat dissipation fins 36 may be spaced apart a distance sufficient to allow air flow there between, which may accelerate dissipation of heat from housing 12. The heat dissipation fins 36 may be particularly helpful to remove heat from the LED work light assembly 10 when high intensity LEDs are used in the LED light assembly 14.

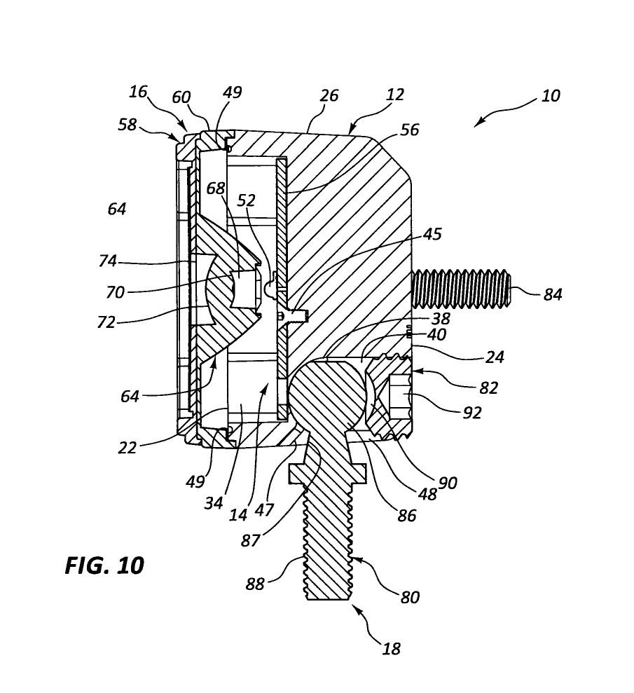

The socket 38 includes a spherical portion as shown in at least FIGS. 9 and 10. The socket 38 is accessible via a socket bore 40 that extends from the rear surface 24 in a forward direction to the socket 38. The socket bore 40 may include a bottom opening 48. The bottom opening 48 may be formed as a slit or channel have a width that is smaller than a maximum width of the socket bore 40. The bottom opening 48 may be arranged in different orientations in other embodiments. For example, when the socket 38 or socket bore 40 are positioned adjacent to a side surface of the housing, the bottom opening 48 may be open along the side surface instead of the bottom surface of the housing 12. Alternatively, the socket bore 40 may extend inward from a side surface of the housing into the socket 38, and the bottom opening 48 is positioned along a top, bottom, or rear surface of the housing.

The mounting bores 42 are sized to receive mounting bolts used for a panel mount of the LED work light assembly. The mounting bores 42 may be arranged facing rearward as shown in the figures. Other arrangements include, for example, bores that face in a top, bottom, or side direction from the housing 12.

The lens attachment bolts 44 may extend through a portion of the housing 12 and into engagement with at least a portion of the lens assembly 16. The lens attachment bolts 44 may be adjusted to connect or disconnect the lens assembly 16 relative to housing 12. The housing 12 may include a sealing member 49 that is positioned along the front surface 22 (see FIG. 9). A portion of the lens assembly 16 may contact the sealing member 49 upon tightening the lens attachment bolts 44 to create a liquid-tight seal between the housing 12 and lens assembly 16.

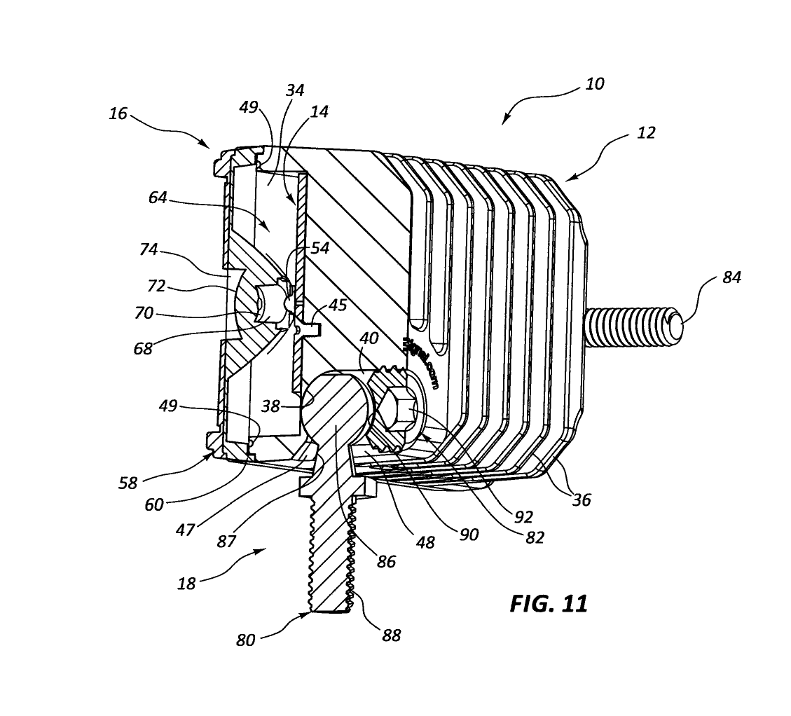

The lens assembly 16 includes an optic member 58 and a lens 60. The optic member includes first, second and third optic portions 62, 64, 66. The optic portions each include a rear opening 68, a rear contoured surface 70, a front contoured surface 72, and a front outlet 74 (see FIGS. 10 and 11). The shape and size of the first, second and third optic portions 62, 64, 66 as well as their orientations relative to the first, second and third LED lights 50, 52, 54, respectively, controls an angle of light output from the LED work light assembly 10. Further, the materials and other physical properties of the optic member 58 and lens 60 may affect light output from the LED work light assembly 10.

As described above, the optic member 58 and other aspects of the lens assembly 16 may be configured to provide one of several different optic selections or light patterns. At least the following light dispersion patterns may be possible: (1) a wide beam having a beam height of about 10° to about 20°, and more preferably about 15°, and a beam width of about 20° to about 35°, and more preferably about 27°, (2) a tight pattern having an angle in the range of about 5° to about 15°, and more preferably about 9°, (3) a spread pattern having an angle of about 20° to about 45°, and (4) a diffuse pattern having an angle of greater than about 45°.

Any combination of these dispersion patterns may be possible when the LED work light assembly includes at least two LEDs and associated optic portions. One such combination is a combination of tight and spread dispersion patterns, which may provide the user an option of directing light on a specific location for enhanced lighting of an object, while also providing a spread dispersion pattern that lights up a broader area around the object with less intense light. The controller 20 of the LED work light assembly 10 may provide the operator with selectability among different combinations of light dispersion patterns. For example, the controller 20 may include a switch that switches the LED lights on and off to add or remove a light dispersion pattern associated with a given LED. The controller 20 may also be used to adjust an intensity of light output from any of the LEDs of the LED light assembly 14. In at least some arrangements, the controller 20 may also include different types of controls for the LEDs including, for example, providing a strobe setting, a flashing setting, or other desired setting.

The optic member 58 and lens 60 are shown as unitary pieces. In other arrangements, a separate optic member may be supplied for each of the LED lights and mounted separately to the housing 12. The housing 12 may include separate light chambers for each LED light and the light chamber is enclosed by securing the separate optic member. Providing a separate optic member for each LED light may enhance customization of the LED work light assembly.

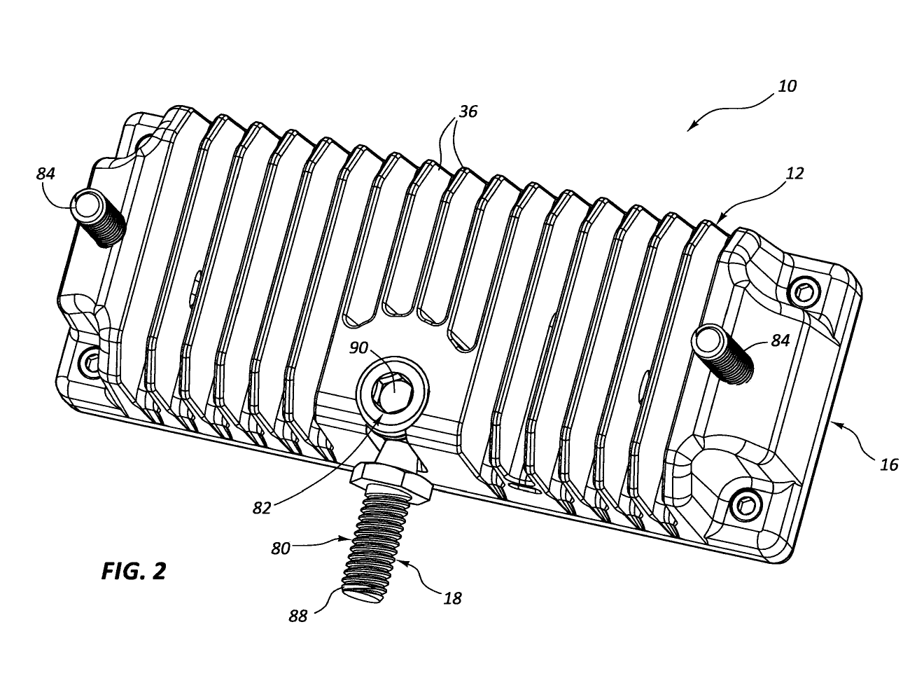

The mounting arrangement 18 includes a bolt 80, a set screw 82 (also referred to as a locking screw), and a plurality of panel mount bolts 84 (see FIGS. 2 and 9-11). The bolt 80 includes a ball 86 mounted to a threaded shank 88. The set screw 82 includes a concave distal surface 90 and a fastener recess 92. The panel mount bolts 84 are mounted within the mounting bores 42 of the housing 12. The panel mount bolts 84 may extend through apertures in a panel or other mounting substrate, and nuts are secured to the panel mount bolts 84 to releasably connect the LED work light assembly 10 to the panel or substrate.

The bolt 80 is mounted to the housing 12 by inserting the ball 86 through the socket bore 40 and into the socket 38 while the threaded shank 88 extends through the bottom opening 48. The set screw 82 is then threaded into the socket bore 40 until the concave surface 90 comes into contact with the ball 86. Further tightening the set screw 82 forces the ball 86 against the socket 38 to fix a rotated position of the housing 12 relative to bolt 80. Loosening the set screw 82 lessens the compression force to permit relative rotation between the housing 12 and bolt 80.

The threaded shank 88 may include a tapered portion having a reduced diameter to permit easier passage through the bottom opening 48. The reduced diameter portion 87 (see FIGS. 9-11) may provide an increased rotation angle of the bolt 80 relative to housing 12. The bottom opening 48 in the housing 12 may have a flared portion 47 that also enhances a possible rotation angle of the bolt 80 relative to housing 12 (see FIGS. 10 and 11).

The set screw 82 is operable to lock a position of the bolt 80 relative to housing 12 by passing through the same aperture or bore through which the ball is inserted to move into the socket 38. The fastener recess 92 may have a hexagonal shape such as, for example, a common Allen wrench socket. A fastener such as an Allen wrench may be inserted into the fastener recess 92 and used to apply a rotation force to advance or withdraw the set screw 82 relative to the ball 86. The concave surface 90 may provide increased surface contact between the set screw 82 and ball 86 as compared to a flat, planar surface. The concave surface 90 may have a radius that mirrors the radius of ball 86. The socket 38 may also have a radius that mirrors the radius of ball 86.

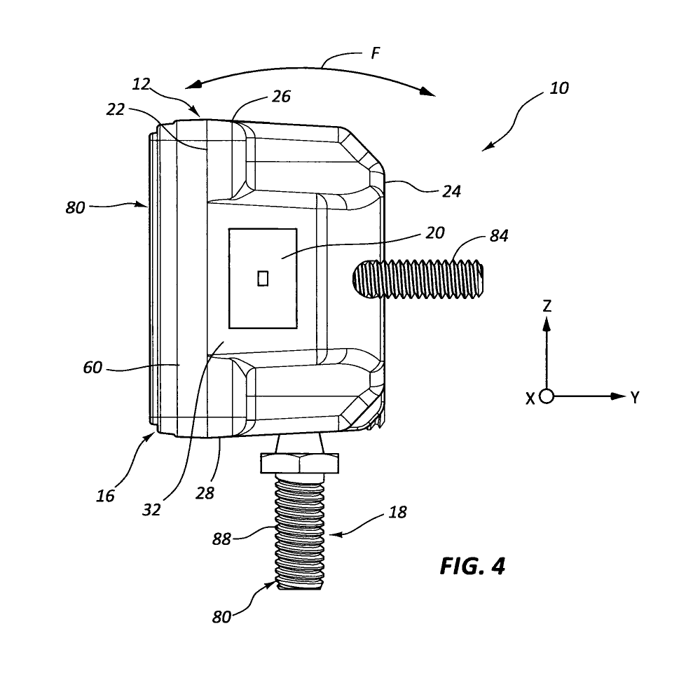

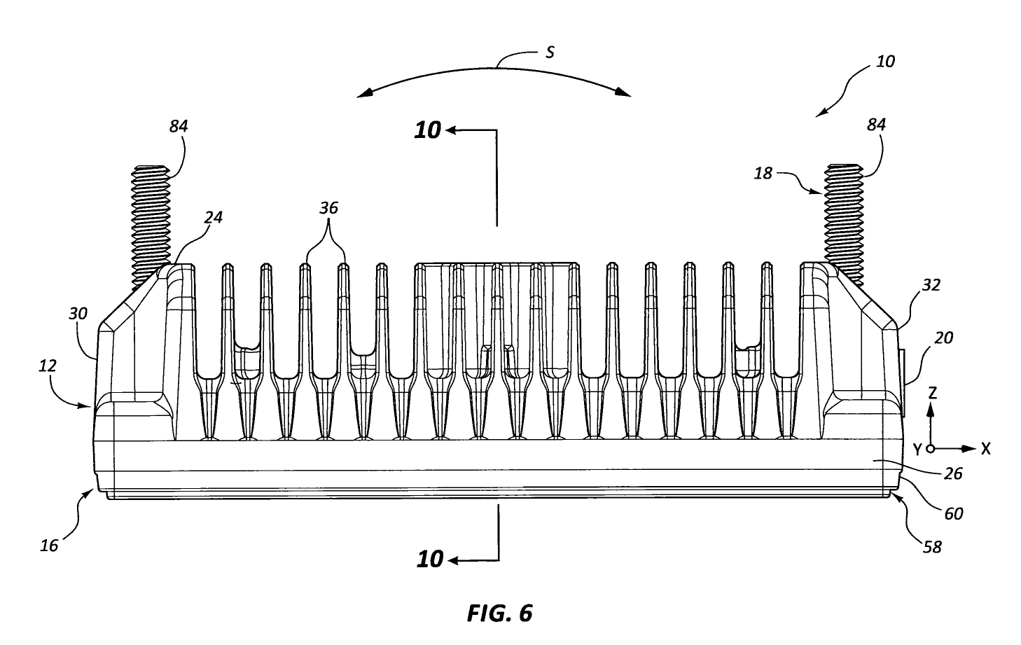

The bolt 80 may be mounted to and extend from the housing 12 in a direction that is different from a direction of insertion of the ball 86 into the socket 38. Once the ball 86 is positioned in the socket 38, the housing 12 may rotate relative to bolt 80 about an interface between the ball 86 and socket 38. FIG. 4 shows rotation about the ball-and-socket joint in a direction F in a forward/back direction of motion about an X-axis. FIG. 5 shows rotation about the ball-and-socket joint in a direction U in a tilting up and down motion about a Y-axis. FIG. 6 shows rotation about the ball-and-socket joint in a direction S in a side-to-side motion about a Z-axis.

The ball-and-socket connection provided by the mounting arrangement 18 provides rotation of the housing 12 relative to the bolt 80 about at least three different axes of rotation. A ball-and-socket mount may also provide rotation about an infinite number of other axes of rotation to provide infinite pivot adjustment of the housing 12 relative to bolt 80.

The mounting arrangement 18 provides multiple options for mounting the LED work light assembly 10. The ball-and-socket connection provided by bolt 80 and set screw 82 may provide the infinite pivoting adjustment described above. Alternatively, the bolt 80 and set screw 82 may be removed and the panel mount bolts 84 may be used to secure the LED work light assembly 10 to a fixed substrate to provide a fixed mounting of the LED work light assembly 10.

The LED work light assembly 10, in the example shown in the figures having 3 LEDs, may have an operating voltage of about 12-24 V, draw current at 12V of about 2.5 amps, and produce 2,400 lumens of light. The LED current may be constant at all voltages. The LED work light assembly 10 may include thermal compensation, may be reverse polarity protected, RFI filtered, and have a NEMA4 rating and IP67 rating.

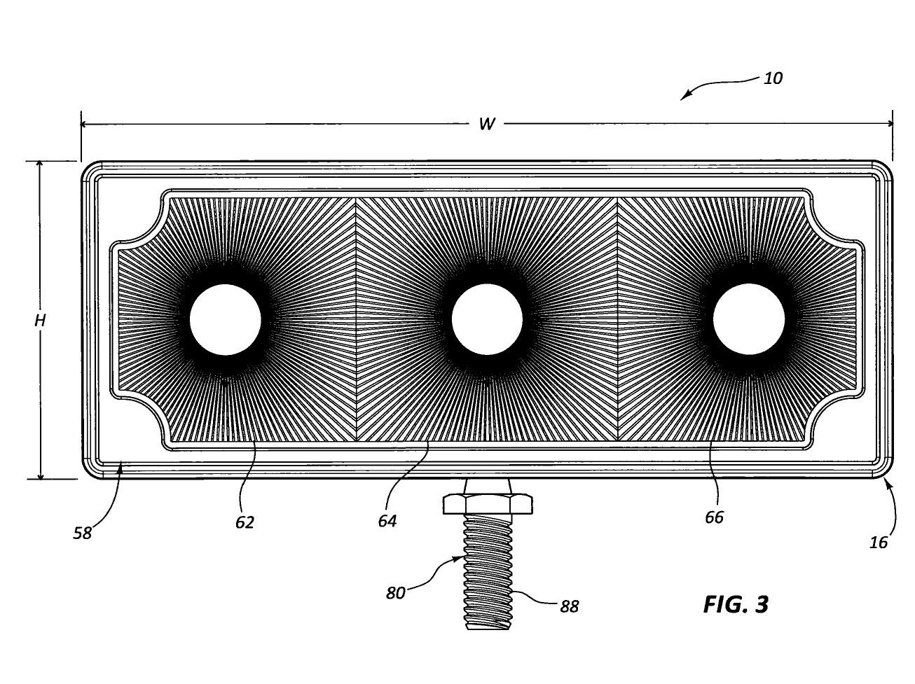

The LED work light assembly 10 may have a variety of different shapes and sizes. While a rectangular shaped LED work light assembly 10 is shown in the drawings, other shapes such as, for example, square, oval, or circular may be used. The LED work light assembly 10 has a height H and a width W as shown in FIG. 3. The height H may be in the range of, for example, about 1 inch to about 24 inches, and preferably in the range of about 2 inches to about 6 inches. The width W may be in the range of about 2 inches to about 36 inches, and more preferably in the range of about 4 inches to about 10 inches.

The LED work light assembly 10 may be connected to a power source by a hard wire, AC power connection. Alternatively, the LED work light assembly 10 may include a mobile power source such as, for example, a set of rechargeable batteries that are housed in the housing 12.

An example method of operating the LED work light assembly includes providing a housing, at least one LED light positioned in the housing, a lens assembly mounted to the housing with a fluid tight connection, a spherical socket formed in the housing, a mounting member having a spherical ball portion, and a locking member. The method includes positioning the ball in the socket, pivoting the housing relative to the mounting member about any one of a plurality of axes of rotation, and moving the locking member into contact with the ball to lock a position of the housing relative to the mounting member. Positioning the ball in the socket may include inserting the ball through a threaded bore, and threadably engaging the locking member into the threaded bore after inserting the ball. The method may also include providing a concave surface on the locking member that contacts the ball to provide a surface contact. Moving the locking member may include rotating the locking member relative to the housing. The mounting member may include a threaded shaft, and the method may further include arranging the threaded shaft extending through a bottom surface of the housing through a slot that intersects with the socket and threaded bore. The housing may include a heat dissipation structure along exterior surface thereof, and the method may further include dissipating heat from the LED work light assembly via the heat dissipation structure. The heat dissipation structure may include a plurality of fins.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. An LED work light assembly, comprising:
a housing defining a light chamber;
a plurality of LED lights positioned in the light chamber;
a lens assembly secured to the housing with a liquid-tight connection to create a waterproof environment in the light chamber;
a mounting arrangement carried by the housing and comprising a pivot mount, the pivot mount comprising:
a spherical socket;
a bolt having a spherical ball positioned at one end and a threaded shaft at an opposite end, the ball being positioned in the socket to provide a ball-and-socket interface, the housing being pivotal about the ball-and-socket interface to adjust a position of the housing relative to the bolt.

2. The LED work light assembly of claim 1, wherein the pivot mount further comprises a locking screw operable to apply a compression force on the ball-and-socket interface to lock a position of the housing relative to the bolt.

3. The LED work light assembly of claim 1, wherein the mounting arrangement further comprises at least first and second panel mount members extending from a rear surface of the housing and configured to secure the LED work light assembly to a mounting structure.

4. The LED work light assembly of claim 1, wherein the lens assembly comprises a separate optic for each of the plurality of LED lights.

5. The LED work light assembly of claim 1, wherein the plurality of LED lights generate a total of at least 2,000 lumens of light for the LED work light assembly.

6. The LED work light assembly of claim 1, wherein the light chamber is open along a front surface of the housing.

7. The LED work light assembly of claim 1, wherein the plurality of LED lights draw about 30 Watts of power.

8. The LED work light assembly of claim 4, wherein the optics are configured to control a direction of light emitted from the plurality of LED lights.

9. The LED work light assembly of claim 8, wherein the direction of light is one of a less than 10° tight pattern and a 15°×27° wide pattern.

10. The LED work light assembly of claim 1, further comprising an actuator accessible on an exterior of the housing and operable to change a setting of at least one of the plurality of LED lights.

11. An LED work light assembly, comprising:
a housing having a light chamber accessible along a front surface of the housing;
a plurality of independently controllable LED lights positioned in the light chamber;
a lens assembly mounted to the front surface of the housing and having a fluid-tight interface with the housing, the lens assembly including a separate optic associated with each of the plurality of LED lights, the optics restricting a direction of light output from the plurality of LED lights;
a ball-and-socket mount connected to the housing and providing unrestricted pivotal movement of the housing about multiple axis of rotation.

12. The LED work light assembly of claim 11, wherein the ball-and-socket mount comprises a spherical socket formed in the housing, and a mounting bolt having a spherical shaped ball at one end thereof that is positioned in the spherical socket.

13. The LED work light assembly of claim 11, further comprising a locking member operable to fix a rotated position of the ball relative to the socket.

14. The LED work light assembly of claim 12, wherein the mounting bolt extends vertically downward from a bottom surface of the housing.

15. The LED work light assembly of claim 13, wherein the locking member comprises a threaded shaft having a distal end that contacts the ball to apply a compression force on the ball.

16. The LED work light assembly of claim 11, wherein the housing comprises a plurality of fins along an exterior surface thereof, the plurality of fins providing heat dissipation from the LED work light assembly.

17. The LED work light assembly of claim 16, wherein at least some of the plurality of fins are positioned along a rear surface of the housing and extend away from the lens assembly.

18. A method of operating an LED work light assembly, comprising:
providing a housing, at least one LED light positioned in the housing, a lens assembly mounted to the housing with a fluid-tight connection, a spherical socket formed in the housing, a mounting member having a ball with a spherical portion, and a locking member;
positioning the ball in the socket;
pivoting the housing relative to the mounting member about any one of a plurality of axis of rotation;
moving the locking member into contact with the ball to lock a position of the housing relative to the mounting member.

19. The method of claim 18, wherein positioning the ball in the socket includes inserting the ball through a threaded bore, the locking member threadably engaging the threaded bore after inserting the ball.

20. The method of claim 18, wherein the locking member includes a concave portion that contacts the ball to provide a surface contact.

21. The method of claim 18, wherein moving the locking member includes rotating the locking member relative to the housing.

22. The method of claim 18, wherein the mounting member includes a threaded shaft, the method further comprising arranging the threaded shaft extending from a bottom surface of the housing.

23. The method of claim 18, wherein the housing further comprises a heat dissipation structure along an exterior surface thereof, the method further comprising dissipating heat from the plurality of LED lights through the heat dissipation structure.
